(19) United States
(12) Patent Application Publication
(10) Pub. No.: US 2017/0131922 A1
(43) Pub. Date: May 11, 2017

(54) MEMORY DEVICE DOWN-TIME

(71) Applicant: International Business Machines Corporation, Armonk, NY (US)

(72) Inventors: Thomas D. Cocagne, Elk Grove Village, IL (US); Manish Motwani, Chicago, IL (US); Jason K. Resch, Chicago, IL (US)

(21) Appl. No.: 15/416,120

(22) Filed: Jan. 26, 2017

Related U.S. Application Data
(63) Continuation-in-part of application No. 15/082,887, filed on Mar. 28, 2016.
(60) Provisional application No. 62/168,145, filed on May 29, 2015.

(51) Int. Cl. G06F 3/06; G06F 11/10

(52) U.S. Cl. CPC G06F 3/0617; G06F 11/1092; G06F 3/067; G06F 3/0619; G06F 3/064; G06F 3/0659

(57) ABSTRACT

A dispersed storage network (DSN) includes at least one DSN processing unit and at least one DSN memory including multiple storage units. The DSN processing unit stores encoded data slices across the multiple storage units. The data slices allow reconstruction of source data associated using fewer than all of the data slices, while preventing reconstruction of the source data using less than a threshold number of the data slices. A received message requesting access to the DSN memory is associated with a time. based on the time associated with the message, the DSN processing unit can determine that at least one memory device included in at least one storage unit is unavailable. That storage unit is excluded from storage units chosen for use by the DSN processing unit in providing the requested access. The DSN then executes the requested access using the chosen storage units.

### CROSS-REFERENCE TO RELATED APPLICATIONS

The present U.S. Utility Patent Application claims priority pursuant to 35 U.S.C. §120 as a continuation-in-part of U.S. Utility application Ser. No. 15/082,887, entitled “TRANSFERRING ENCODED DATA SLICES IN A DISPERSED STORAGE NETWORK,” filed Mar. 28, 2016, which claims priority pursuant to 35 U.S.C. §119(e) to U.S. Provisional Application No. 62/168,145, entitled “TRANSFERRING ENCODED DATA SLICES BETWEEN STORAGE RESOURCES,” filed May 29, 2015, both of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

Technical Field of the Invention

This invention relates generally to computer networks and more particularly to dispersing error encoded data.

Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

To maintain optimal utilization of memory resource such as those used in Internet storage systems, various maintenance functions, such as defragmentation, compaction, and relocalization, may need to be performed. However, if a system is under constant and perpetual load, it can sometimes be difficult to schedule times to perform the necessary internal maintenance functions needed for the individual memory devices without negatively impacting system performance.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an embodiment of a distributed computing system in accordance with the present invention; and

FIG. 10 is a flowchart illustrating an example of selecting storage resources of a dispersed storage network (DSN) memory for access based on a deterministic time function in accordance with the present invention.

### DETAILED DESCRIPTION OF THE INVENTION

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (10) controller 56, a peripheral component interconnect (PCI) interface 58, an 10 interface module 60, at least one 10 device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the 10 device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

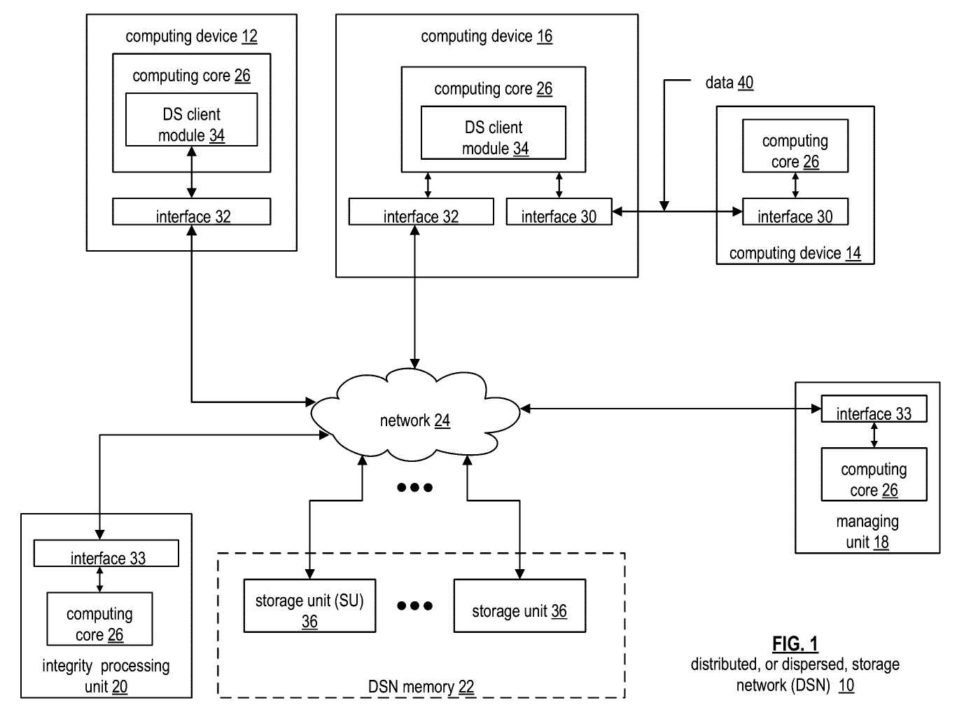

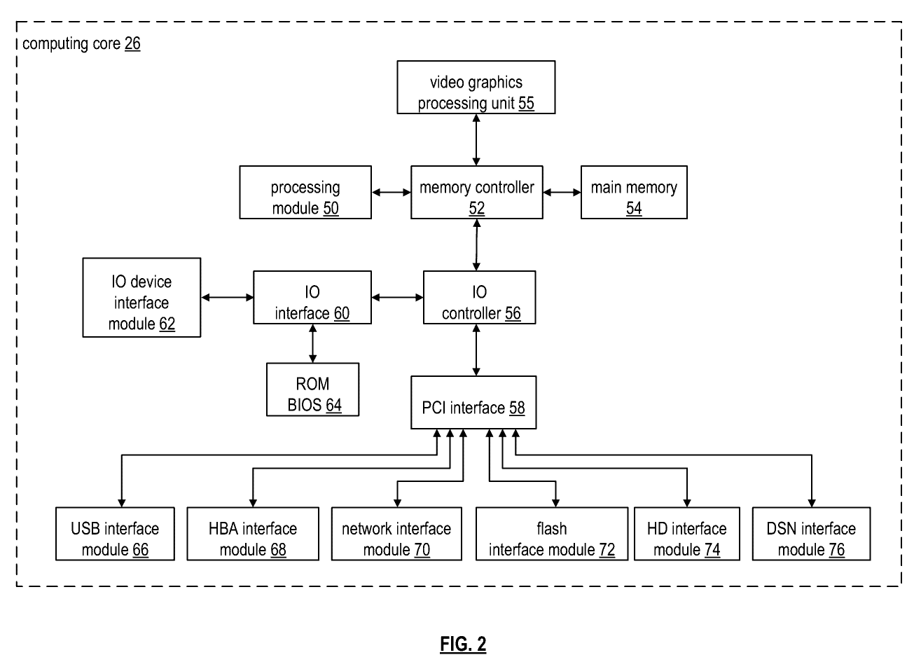

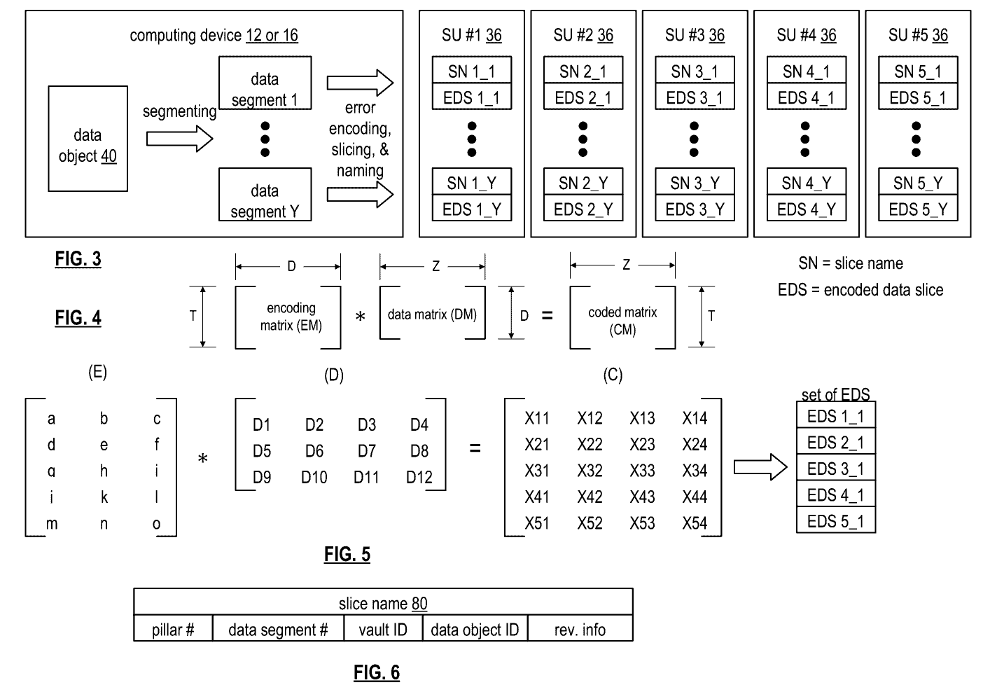

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

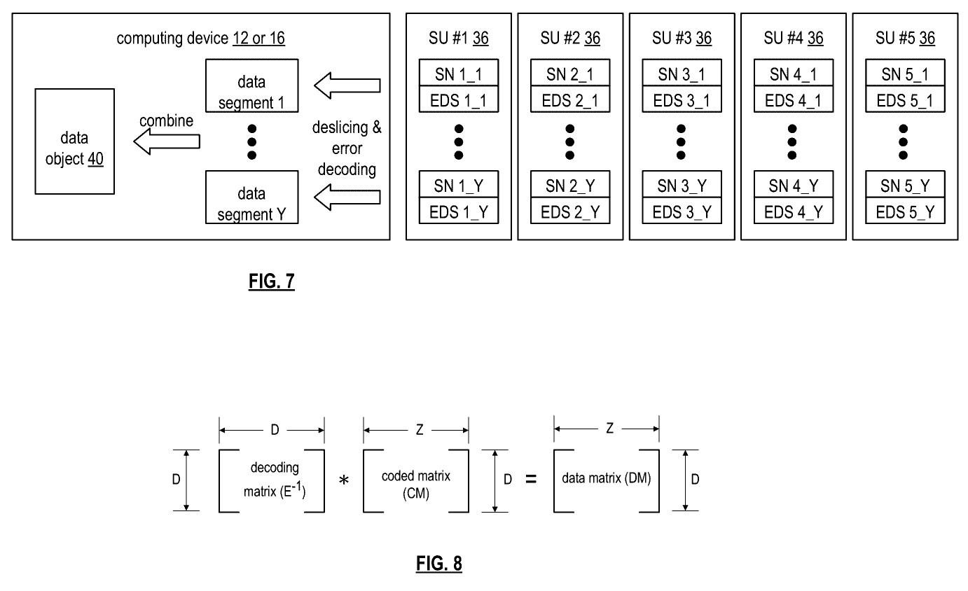

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

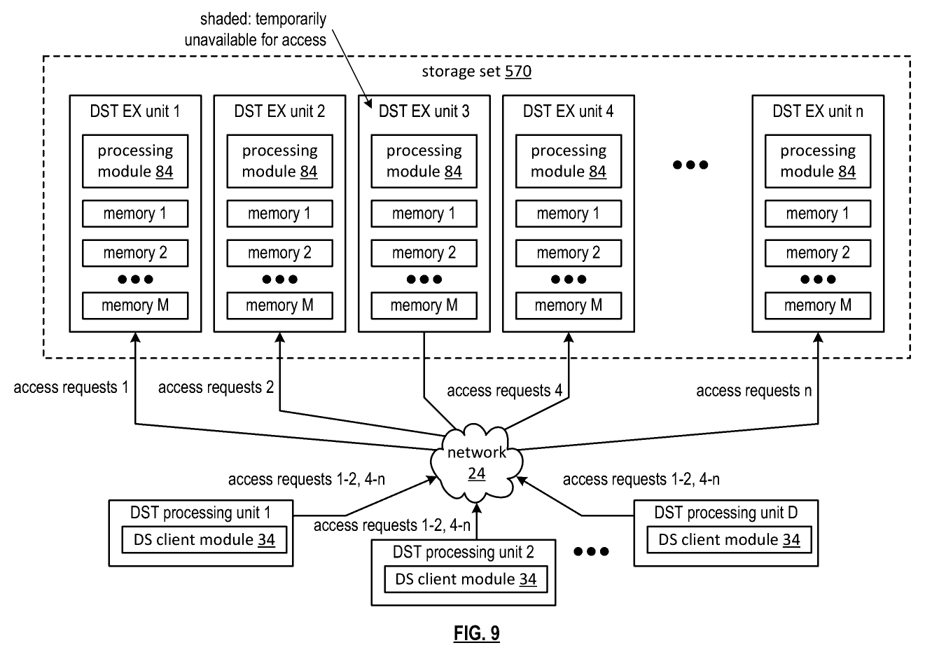

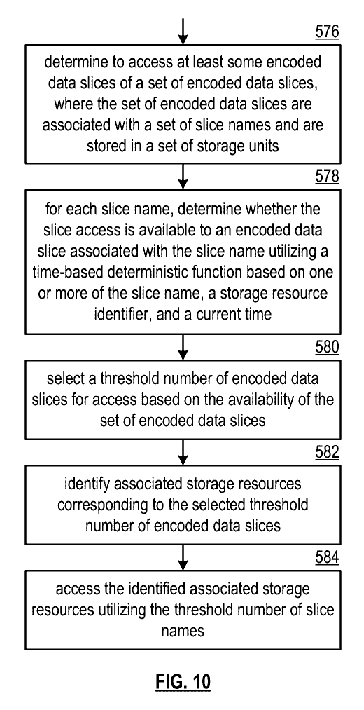

Referring to FIGS. 9 and 10 various embodiments that can be used to provide scheduled times of reduced activity for memory devices used in distributed storage systems will be discussed. In at least some embodiments, some memory devices can benefit from being given occasional “time off”, e.g. no access requests during some time period, in order to perform necessary internal maintenance functions such as defragmentation, compaction, re-localization, or other such performance or capacity optimizing operations. A distributed storage network (DSN) processing unit can factor this occasional time off into its operation, especially in a target width scenario where the DSN processing unit has flexibility to not write to all locations at all times.

In at least some embodiments, multiple DSN processing units use the same time-based deterministic function to synchronize themselves to that DSN storage units within a DSN memory, or sub ranges of the global namespace, will have certain pillars utilized, or excluded from use, at certain times. In this way, some embodiments provide for every DSN storage unit and/or memory device to have periods of inactivity, or at least no activity induced from requests originating externally from the DSN storage unit or memory device, on a periodic or round-robin basis. In some implementations, memory devices within a DSN storage unit can be provided periods of inactivity so long as the sub-ranges of the namespace are larger than the ranges covered by individual memory devices. These periods of reduced or no activity can be used to enable particular memory devices to perform critical maintenance functions, even in a DSN that is under constant and perpetual load.

FIG. 9 is a schematic block diagram of another embodiment of a dispersed storage network (DSN) that includes a storage set 570, which can be a DSN memory 22 as in FIG. 1, the network 24 of FIG. 1, and a plurality of distributed storage and task (DST) processing units 1-D, such as computing devices 12, 16, and 14 of FIG. 1. The storage set, or DSN memory, includes a set of DST execution (EX) units 1-n, e.g. storage units 36 of FIG. 1. Each DST execution unit includes a processing module 84, which can be similar to computing core 26 of FIG. 2, and a plurality of memories 1-M. Each memory may be implemented utilizing the one or more physical memory devices. Each DST execution unit may be implemented utilizing the storage unit 36 of FIG. 1. Hereafter, each DST execution unit may be interchangeably referred to as a storage unit and the storage set may be interchangeably referred to as a set of storage units, or a DSN memory. Each DST processing unit includes the DS client module 34 of FIG. 1. Each DST processing unit may be implemented utilizing the DS processing unit 16 of FIG. 1. The DSN functions to select storage resources of the storage set for access based on a deterministic time function.

In an example of operation of the selecting of the storage resources, a DS client module 34 of FIG. 1 of a DST processing unit determines to access at least some encoded data slices of a set of encoded data slices, where the set of encoded data slices are stored in the storage set in accordance with an associated set of slice names and where the associated set of slice names maps to a set of memory devices of the storage set. For example, a particular set of encoded data slices are stored in the memory 1 of each of the DST execution units (e.g., an encoded data slice 1 in the DST execution unit 1, an encoded data slice 2 in the DST execution unit 2, etc.). The determining may include one or more of receiving a data access request and identifying the set of slice names.

Having determined to access the at least some of the encoded data slices of the set of encoded data slices, for each slice name of the set of slice names, the DS client module 34 of the DST processing unit determines whether slice access is available utilizing a time-based deterministic function based on the slice name, a storage resource identifier (e.g., a memory device identifier, a storage unit identifier) and a current time. The determining includes one or more of mapping the slice name to one or more storage resource identifiers of (e.g., performing a lookup) and applying the deterministic function to the slice name, the storage resource identifier, and the current time to produce an availability indicator (e.g., available, not available). For example, the DS client module 34 determines that all encoded data slices except for an encoded data slice 3 stored in a memory of the DST execution unit 3 are currently available for access.

Having determined the availability of slice access, the DS client module 34 selects a threshold number of encoded data slices for access based on the availability of slice access. For example, the DS client module 34 determines the threshold number (e.g., a write threshold for a write operation, a read threshold for a read operation) and chooses the determined threshold number of encoded data slices for access, where only available encoded data slices are selected.

Having selected the encoded data slices for access, the DS client module 34 identifies associated available storage resources corresponding to the selected threshold number of encoded data slices. For example, the DS client module 34 maps a corresponding threshold number of slice names to storage resources (e.g., to member devices, the storage units). For instance, the DS client module 34 identifies memories at storage units excluding the DST execution unit 3.

Having identified the available storage resources, the DS client module 34 accesses the identified storage resources utilizing the threshold number of slice names. For example, the DS client module 34 generates a threshold number of access requests (e.g., access requests 1-2, 4-n) that includes the threshold number of slice names, and sends, via the network 24, the generated access requests to the associated storage units. As such, when each DST processing utilizes the time-based deterministic function to select the threshold number of encoded data slices at common identified associated available storage resources, a system improvement may be provided where excluded resources may perform non-access operations (e.g., maintenance functions, defragmentation, compaction, re-localization, or other such capacity and performance optimizing operations) during a time frame in accordance with the time-based deterministic function.

FIG. 10 is a flowchart illustrating an example of selecting storage resources of a dispersed storage network (DSN) memory for access based on a deterministic time function. The method includes block 576 where a processing module (e.g., of a distributed storage and task (DST) processing unit) determines to access at least some encoded data slices of a set of encoded data slices, where the set of encoded data slices are associated with a set of slice names and are stored in a set of storage units. For example, the processing module receives a data access request and identifies the set of slice names utilizing a dispersed hierarchical index lookup.

For each slice name, the method continues at block 578 where the processing module determines whether the slice access is available to an encoded data slice associated with the slice name utilizing a time-based deterministic function based on one or more of the slice name, a storage resource identifier, and a current time. For example, the processing module maps the slice name to one or more storage resource identifiers (e.g., performing a lookup), applies the deterministic function to the slice name, a storage resource identifier, and the current time to produce an availability indicator (e.g., available, not available).

The method continues at block 580 where the processing module selects a threshold number of encoded data slices for access based on the availability of the set of encoded data slices. For example, the processing module determines the threshold number (e.g., a write threshold for a write operation, a read threshold for a read operation), and chooses the determined threshold number of encoded data slices for access when the slice access is available.

The method continues at block 582 where the processing module identifies associated storage resources corresponding to the selected threshold number of encoded data slices. The identifying includes at least one of mapping a corresponding threshold number of slice names to storage resources (e.g., to member devices, to storage units), performing a lookup, and interpreting a query response.

The method continues at block 584 where the processing module accesses the identified associated storage resources utilizing the threshold number of slice names. For example, the processing module generates a threshold number of access requests that includes the threshold number of slice names and sends the generated access requests to the associated storage units.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for use in a dispersed storage network (DSN) including at least one DSN processing unit and at least one DSN memory including a plurality of storage units, the method comprising:
storing, under control of the at least one DSN processing unit, a plurality of encoded data slices across the plurality of storage units included in the at least one DSN memory, the encoded data slices encoded to allow reconstruction of source data associated with the encoded data slices using fewer than all of the encoded data slices while preventing reconstruction of the source data using less than a threshold number of the encoded data slices;
receiving a first access request message at the at least one DSN processing unit, the first access request message requesting access to the at least one DSN memory, wherein the first access request message is associated with a first time;
determining, based on the first time associated with the first access request message, that at least one memory device included in at least one storage unit is unavailable;
excluding the at least one storage unit from a plurality of selected storage units chosen by the at least one DSN processing unit to be used in executing the first access request message; and
executing the first access request message using the selected storage units.

2. The method of claim 1, further comprising:
receiving a second access request message at the at least one DSN processing unit, the second access request message requesting access to the at least one DSN memory, wherein the second access request message is associated with a second time;
determining that the at least one memory device within the at least one storage unit is available based on the second time associated with the second access request message;
including the at least one storage unit in a plurality of selected storage units chosen by the at least one DSN processing unit to be used in executing the second access request message; and
executing the second access request message using the selected storage units.

3. The method of claim 1, wherein the first access request message is a read request, the method further comprising:
in response to the first access request message retrieving, from the selected storage units, particular encoded data slices of a read-threshold number of encoded data slices stored in the at least one DSN memory.

4. The method of claim 1, wherein the first access request message is a write request, the method further comprising:
in response to the first access request message, writing, to the selected storage units, particular encoded data slices for storage in the at least one DSN memory.

5. The method of claim 1, wherein the determining that at least one memory device within at least one storage unit is unavailable based on the first time associated with the first access request message further includes:
applying a time-based deterministic function to a slice name included in the first access request message.

6. The method of claim 1, wherein the DSN includes a plurality of DSN processing units, the method further comprising:
synchronizing the plurality of DSN processing units to limit access to particular pillars at particular times.

7. The method of claim 6, further comprising:
limiting access to the at least one storage unit on a recurring basis.

8. A dispersed storage network (DSN) processing unit for use in a dispersed storage network (DSN) including at least one DSN memory having a plurality of storage units, the DSN processing unit comprising:
at least one processor and associated memory;
at least one communications interface coupled to the processor, the at least one communications interface configured to:
transmit a plurality of encoded data slices to the at least one DSN memory for storage across the plurality of storage units, the encoded data slices encoded to allow reconstruction of source data associated with the encoded data slices using fewer than all of the encoded data slices while preventing reconstruction of the source data using less than a threshold number of the encoded data slices;
receive a first access request message requesting access to the DSN memory, the first access request message associated with a first time;
the at least one processor and associated memory configured to:
determine, based on the first time associated with the first access request message, that at least one memory device included in at least one storage unit is unavailable;
choose a plurality of selected storage units to be used in executing the first access request message;
exclude the at least one storage unit from the plurality of selected storage units; and
execute the first access request message using the selected storage units.

9. The dispersed storage network (DSN) processing unit of claim 8, wherein:
the at least one communications interface is further configured to:
receive a second access request message at the at least one DSN processing unit, the second access request message requesting access to the DSN memory, wherein the second access request message is associated with a second time;
the at least one processor and associated memory further configured to:
determine that the at least one memory device within the at least one storage unit is available based on the second time associated with the second access request message;
include the at least one storage unit in a plurality of selected storage units chosen to be used in executing the second access request message; and
execute the second access request message using the selected storage units.

10. The dispersed storage network (DSN) processing unit of claim 8, wherein the first access request message is a read request, the at least one processor and associated memory configured to:
in response to the first access request message, use the at least one communications interface to retrieve, from the selected storage units, particular encoded data slices of a read-threshold number of encoded data slices stored in the DSN memory.

11. The dispersed storage network (DSN) processing unit of claim 8, wherein the first access request message is a write request, the at least one processor and associated memory configured to:
in response to the first access request message, use the at least one communications interface to write, to the selected storage units, particular encoded data slices for storage in the DSN memory.

12. The dispersed storage network (DSN) processing unit of claim 8, wherein the at least one processor and associated memory are configured to:
apply a time-based deterministic function to a slice name included in the first access request message.

13. The dispersed storage network (DSN) of claim 8, wherein the DSN includes at least one additional DSN processing unit, and the at least one processor and associated memory are further configured to:
synchronize with the at least one additional DSN processing unit to limit access to particular pillars at particular times.

14. The dispersed storage network (DSN) processing unit of claim 13, the at least one processor and associated memory further configured to:
limit access to the at least one storage unit on a recurring basis.

15. A dispersed storage network (DSN) comprising:
at least one DSN processing unit including a processor and associated memory;
at least one DSN memory including a plurality of storage units, the DSN memory configured to store, under control of the at least one DSN processing unit, a plurality of encoded data slices across the plurality of storage units, the encoded data slices encoded to allow reconstruction of source data associated with the encoded data slices using fewer than all of the encoded data slices while preventing reconstruction of the source data using less than a threshold number of the encoded data slices;
the at least one DSN processing unit configured to:
receive a first access request message requesting access to the at least one DSN memory, wherein the first access request message is associated with a first time;
determine, based on the first time associated with the first access request message, that at least one memory device included in at least one storage unit is unavailable;
exclude the at least one storage unit from a plurality of selected storage units chosen to be used in executing the first access request message; and
execute the first access request message using the selected storage units.

16. The dispersed storage network (DSN) of claim 15, the at least one DSN processing unit further configured to:
receive a second access request message at the at least one DSN processing unit, the second access request message requesting access to the at least one DSN memory, wherein the second access request message is associated with a second time;
determine that the at least one memory device within the at least one storage unit is available based on the second time associated with the second access request message;
include the at least one storage unit in a plurality of selected storage units to be used in executing the second access request message; and
execute the second access request message using the selected storage units.

17. The dispersed storage network (DSN) of claim 15, wherein the first access request message is a read request, and the at least one DSN processing unit further configured to:
in response to the first access request message, use the at least one communications interface to retrieve, from the selected storage units, particular encoded data slices of a read-threshold number of encoded data slices stored in the at least one DSN memory.

18. The dispersed storage network (DSN) of claim 15, wherein the first access request message is a write request, and the at least one DSN processing unit further configured to:
in response to the first access request message, use the at least one communications interface to write, to the selected storage units, particular encoded data slices for storage in the at least one DSN memory.

19. The dispersed storage network (DSN) of claim 15, the at least one DSN processing unit further configured to:
apply a time-based deterministic function to a slice name included in the first access request message.

20. The dispersed storage network (DSN) of claim 15, further comprising:
at least one additional DSN processing unit; and
wherein the at least one DSN processing unit is further configured to synchronize with the at least one additional DSN processing unit to limit access to particular pillars at particular times on either a round-robin or period basis.
